(19) United States
(12) Patent Application Publication
(10) Pub. No.: US 2016/0160394 A1
(43) Pub. Date: Jun. 9, 2016

(54) METHOD FOR PRODUCING AN EFFICIENT CATALYST FOR GENERATING MULTI-WALLED CARBON NANOTUBES, MULTI-WALLED CARBON NANOTUBES AND CARBON NANOTUBE

(71) Applicant: COVESTRO DEUTSCHLAND AG, Leverkusen (DE)

(72) Inventors: Heiko HOCKE, Leverkusen (DE); Stefan GRASSER, Leverkusen (DE); Oliver Felix Karl SCHLÜTER, Leverkusen (DE)

(21) Appl. No.: 14/906,034

(22) PCT Filed: Jul. 14, 2014
(86) PCT No.: PCT/EP2014/065005

§ 371 Date: Jan. 19, 2016

(30) Foreign Application Priority Data
Jul. 19, 2013 (DE) 10 2013 214 229.3

(51) Int. Cl. D01F 9/12; B01J 35/02; B01J 37/04; B01J 37/16; B01J 37/06; B01J 37/08; B01J 37/02; B01J 23/889; B01J 37/03

(52) U.S. Cl. CPC D01F 9/12; B01J 23/8892; B01J 35/023; B01J 37/04; B01J 37/031; B01J 37/06; B01J 37/08; B01J 37/0236; B01J 37/16

(57) ABSTRACT

The invention relates to a method for producing a catalyst for the synthesis of multi-walled carbon nanotubes. The invention also relates to a method for producing multi-walled carbon nanotubes and a carbon nanotube powder with improved properties and comprising said carbon nanotubes.

The invention relates to a process for producing a catalyst for the synthesis of multi-wall carbon nanotubes. The invention further relates to a process for producing multi-wall carbon nanotubes and also a carbon nanotube powder which comprises these carbon nanotubes and has improved properties.

According to the prior art, carbon nanotubes are mainly cylindrical carbon tubes having a diameter in the range from 1 to 100 nm and a length which is a multiple of the diameter. These tubes consist of one or more layers of ordered carbon atoms and have a core having a different morphology. These carbon nanotubes are also referred to as, for example, “carbon fibrils” or “hollow carbon fibers”.

Carbon nanotubes have been known for a long time in the technical literature. Although Iijima (publication: S. Iijima, Nature 354, 56-58, 1991) is generally credited with being the discoverer of nanotubes, these materials, in particular fibrous graphite materials having a plurality of graphene layers, were known as early as the 1970s or early 1980s. Tates and Baker (GB 1469930A1, 1977 and EP 0056004A2, 1982) first describe the deposition of very fine fibrous carbon from the catalytic decomposition of hydrocarbons. However, the carbon filaments produced on the basis of short-chain hydrocarbons are not characterized in more detail in respect of their diameter.

The production of carbon nanotubes having diameters of less than 100 nm was described for the first time in EP 205 556B1 or WO 86/03455A1. These were produced using light (i.e. short- and medium-chain aliphatic or monocyclic or bicyclic aromatic) hydrocarbons and an iron-based catalyst over which carbon carrier compounds are decomposed at a temperature above 800° C.−900° C.

The methods known today for producing carbon nanotubes encompass electric arc processes, laser ablation processes and catalytic processes. In many of these processes, carbon black, amorphous carbon and fibers having large diameters are formed as by-products. Among catalytic processes, a distinction can be made between the deposition on introduced catalyst particles and deposition on metal sites which are formed in-situ and have diameters in the nanometer range (known as flow processes). In the production route via catalytic deposition of carbon from hydrocarbons which are gaseous under the reaction conditions (hereinafter referred to as CCVD; catalytic carbon vapor deposition), acetylene, methane, ethane, ethylene, butane, butene, butadiene, benzene and further carbon-containing starting materials have been mentioned as possible carbon donors.

The catalysts generally comprise metals, metal oxides or decomposable or reducible metal components. For example, Fe, Mo, Ni, V, Mn, Sn, Co, Cu and others are mentioned in the prior art as metals coming into question for catalysts. Although the individual metals usually have, even alone, a tendency to catalyze the formation of nanotubes. However, according to the prior art, high yields of nanotubes and small proportions of amorphous carbons are advantageously achieved using metal catalysts which contain a combination of the abovementioned metals.

Particularly advantageous catalyst systems are, according to the prior art, based on combinations containing Fe, Co or Ni. The formation of carbon nanotubes and the properties of the tubes formed depend in a complex way on the metal component or a combination of several metal components used as catalyst, the support material used and the interaction between catalyst and support, the feed gas and feed gas partial pressure, an addition of hydrogen or further gases, the reaction temperature and the residence time and the reactor used. Optimization is a particular challenge for an industrial process.

Typical structures of carbon nanotubes are those of the cylinder type (tubular structure). In the case of cylindrical structures, a distinction is made between single-wall carbon nanotubes (SWCNT) and multi-wall carbon nanotubes (MWCNT). Customary processes for producing them are, for example, electric arc processes (arc discharge), laser ablation, chemical deposition from the vapor phase (CVD process) and catalytic chemical deposition from the vapor phase (CCVD process).

Cylindrical carbon nanotubes of this type can likewise be produced by an electric arc process. Iijima (Nature 354, 1991, 56-8) reports the formation of carbon tubes which consist of two or more graphene layers which are rolled up to form a seamless closed cylinder and are nested within one another by means of an electric arc process. Depending on the rolling-up vector, chiral and achiral arrangements of the carbon atoms along the longitudinal axis of the carbon fiber are possible.

Carbon nanotubes having a scroll structure in which one or more graphite layers consisting of two or more superposed graphite layers form a rolled structure can be produced by the process described in WO 2009/036877 A2.

Further known structures of carbon nanotubes are described in a review (Milne et al. Encyclopedia of Nanoscience and Nanotechnology, 2003, Volume X, pp. 1-22; ISBN 1-58883-001-2), and are the “herringbone” structure or the cup-stacked structure and the stacked structure, the bamboo structure, the platelet structure. Carbon nanofibers can likewise be produced by electrospinning of polyacrylonitrile and subsequent graphitization (Jo et al. Macromolecular Research, 2005, Volume 13, pp. 521-528).

It may be remarked that the metal component used in CCVD and referred to as catalyst is consumed during the course of the synthesis process. This consumption is attributable to deactivation of the metal component, e.g. as a result of deposition of carbon on the entire particle, which leads to complete covering of the particle (this is known as “encapping” to a person skilled in the art). Reactivation is generally not possible or not economically feasible. Often, only a few grams at most of carbon nanotubes are obtained per gram of catalyst, with the catalyst here comprising the totality of support and catalyst used. Owing to the abovementioned consumption of catalyst, a high yield of carbon nanotubes based on the catalyst used is an important requirement which has to be met by catalyst and process.

With the increasing industrial and technological importance of carbon nanotubes, not only the requirements for a highly efficient, economical and scalable production process of CNT but also the nature and properties of the carbon nanotubes or the carbon nanotube powders composed of these, in particular in respect of purity, processability and performance, have increased. In order to achieve a very high economic efficiency, not only the costs for the raw material, in particular the catalyst costs, but also the space-time yield, i.e. the amount of CNT which can be produced per unit time in a particular reactor volume, are of critical importance.

In the prior art, a way of producing cylindrical carbon nanotubes has been described by Oberlin, Endo and Koyama (Carbon 14, 1976, 133); here, aromatic hydrocarbons such as benzene are reacted over a metal catalyst, in particular iron, at about 1100° C. in an entrained-flow reactor. Here, carbon nanotubes having a graphitic core are formed, although the core is covered by a coating of amorphous carbon. A subsequent technically complicated and expensive thermal treatment at high temperatures, generally above 1800° C., of these fibers then leads to a product comprising predominantly graphitic carbon. Here, part of the catalyst is frequently also removed, which effects purification. The product is only very slightly entangled or not entangled, which makes handling very difficult because of the low bulk density and the extreme dusting behavior.

A further process for producing carbon nanotubes is described in U.S. Pat. No. 7,198,772B2 (Hyperion Catalysis International); here, ethylene is reacted over an iron-containing catalyst at temperatures of about 680° C. The catalysts used for the CNT synthesis are obtained either by precipitation of active metal, usually iron and molybdenum, on a support such as aluminum oxide, aluminum hydroxide or magnesium oxide or else by coprecipitation of active metal and support. The CNTs produced in this way are isolated in the form of aggregates in yields of 11.4-46 g of CNT per 1 g of catalyst. The coprecipitated catalysts generally display a greater efficiency.

The patent application WO 2006/050903 (Bayer MaterialScience AG) describes a catalyst system which can be utilized very efficiently for producing carbon nanotubes. Here, cobalt salts, manganese salts, magnesium salts and aluminum salts are coprecipitated simultaneously under basic conditions.

The patent application WO 2009/043445A1 describes the production of a catalyst by means of spray drying; here, the starting salts can partly also be present as a dispersion in a solvent. However, coprecipitation does not take place, especially not under basic conditions. The yields were from about 25 to 34 g of carbon nanotubes per gram of catalyst used.

In conclusion, the above-described prior art makes it possible to produce carbon nanotubes in high purity and with low costs to only a limited extent.

It is an object of the present invention to provide a supported catalyst which firstly can in itself be produced inexpensively but on the other hand makes it possible to produce carbon nanotubes with increased efficiency both in respect of the catalyst used and also the space-time yield in the reactor.

It is a further object of the invention to provide an improved CNT production process in which carbon nanotubes having high quality and excellent properties, e.g. a very high surface area, can be obtained. For economic reasons, it is also desirable to have a catalyst which allows different CNTs optimized to the respective desired use, especially with different specific surface areas, to be produced by only slight variation of the CNT production conditions, e.g. the temperature, with otherwise virtually identical reactor structure and process.

According to the invention, the object is achieved by means of a process for producing a catalyst consisting of at least one or more active metals and one or more support materials, which comprises the following steps:
a) initial charging of a substrate in powder form which serves as support material for the catalyst and dispersion of the substrate powder in a solvent by mechanical action and setting of the dispersion to a pH of at least 8, preferably at least 9, particularly preferably at least 9.5, and not more than 13,
b) addition of one or more metal salt solutions containing precursor compounds of catalytically active metals and support metals, optionally after resetting of the selected pH so that these are coprecipitated and at the same time deposited on the previously dispersed substrate powder,
c) removal and isolation of the precipitated solid,
d) optionally washing of the solid with solvent,
e) spray-drying or drying and optionally milling and/or sieving (classification),
f) optionally calcinng at 200° C.-950° C., preferably 400° C.-900° C., particularly preferably 400° C.-850° C., with reduction or oxidation with subsequent reduction,
g) reduction of the catalyst material formed.

As suitable precursor compounds of the catalytically active metals, preference is given to using those of one or more metals selected from the group consisting of: iron, cobalt, nickel, manganese and molybdenum.

Particular preference is given to using compounds of cobalt and manganese, preferably in admixture, as precursor compounds.

Preferred suitable precursor compounds for support materials are selected from among one or more compounds of the group of compounds of magnesium, aluminum, silicon, titanium, barium or calcium.

Particularly preferred precursor compounds for support materials are compounds of magnesium and/or aluminum.

The average particle diameter of the initially charged substrate powder in step a) is preferably less than 1 mm, particularly preferably less than 0.1 mm and in particular less than 0.02 mm.

Preferred precursor compounds for catalyst or support are, independently of one another, water-soluble salts, in particular nitrates, nitrites, chlorides, sulfates, carboxylates, in particular acetates or citrates, of the abovementioned metals. The metal compounds are particularly preferably present as nitrates or acetates.

A preferred embodiment of the novel process is characterized in that the metals are present in the form of their oxides or hydroxides, mixed oxides/hydroxides, or mixed oxides or mixed hydroxides in the isolated solid from step c).

In a further preferred process, the particle diameter of the main fraction of the catalyst after spray drying and/or milling and sieving as per step e) is in the range from 0.01 to 1 mm, preferably from 0.02 to 0.25 mm and in particular from 0.03 to 0.12 mm.

The novel catalyst production process is preferably carried out using one or more solvents selected from the group consisting of: water, alcohols, ethers, ketones as solvents for steps a), b) and optionally d). Particular preference is given to using water as solvent.

In a further preferred variant of the novel process, the dispersion is intensively homogenized, in particular by stirring or by means of high-pressure dispersion, during the addition of the metal salt solution in step b).

In another preferred embodiment of the novel process, the setting and resetting of the pH in the dispersion is effected by means of alkali metal hydroxide or ammonium hydroxide or alkali metal carbonate or ammonium carbonate or alkali metal hydrogencarbonate or ammonium hydrogencarbonate, in particular by means of alkali metal hydroxide or ammonium hydroxide. These materials are, in particular, added in the form of an aqueous solution to the dispersion.

Preferred alkali metal compounds are those of lithium, sodium or potassium, with particular preference being given to sodium compounds.

The precipitation b) is preferably carried out at a temperature of the dispersion of up to 100° C., preferably at ambient temperature.

A preferred process is characterized in that the ratio of metal content in mol % of the catalytically active metal in the catalyst to metal of the support is from 90/10 to 5/95, preferably from 80/20 to 20/80, particularly preferably from 70/30 to 30/70.

The ratio of the content of the initially charged substrate metal for the catalyst support to precipitated substrate metal for the catalyst support in mol % is from 1/99 to 95/5, in a preferred embodiment of the process from 2/98 to 50/50.

The invention further provides a catalyst obtained from a novel catalyst production process as described above.

The invention also provides for the use of a catalyst produced by the novel catalyst production process as described above for producing fibrous carbon material, in particular carbon nanotubes.

The invention further provides a process for producing fibrous carbon (carbon nanotubes) by production of catalyst using the novel catalyst production process as described above,

The introduction of the catalyst from the catalyst production process into a suitable reactor, preferably having an agitated reaction bed and in particular a fluidized bed.

The production of carbon nanotubes by reaction of carbon-containing gases (precursor) in the presence of the catalyst at elevated temperature, in particular from at least 500° C. to 1000° C., preferably from 550° C. to 850° C., particularly preferably from 600° C. to 750° C., optionally in the presence of hydrogen and/or inert gas, in particular nitrogen and/or noble gas, and discharge of the carbon nanotubes and other reaction products from the reactor.

In the context of the invention, it has been found that, in contrast to the prior art, a process having these steps enables carbon nanotubes to be obtained with very high efficiency, i.e. both very high CNT yields based on the catalyst used and also in respect of the space-time yield in the reactor. In addition, the surface area of the CNTs formed can be altered and set in a targeted manner by variation of the temperature in the CNT production step when using the catalyst of the invention.

In principle, all types of carbon nanotubes are obtainable by the novel production process for carbon nanotubes. Examples of types of carbon nanotubes are: single-wall nanotubes having a single graphene-like layer, multi-wall nanotubes having a plurality of graphene-like layers; carbon nanotubes having a tubular structure, bamboo structure, herringbone structure, cup-stacked structure, roll structure or scroll structure; capped-carbon nanotubes in which at least one tubular graphene-like layer is closed at its ends by fullerene hemispheres; or any possible combination of the abovementioned types and also carbon nanofibers and boron or nitrogen-containing carbon nanotubes (B-CNT, N-CNT).

The carbon nanotube production process will be described in more detail below both in general terms and in specific embodiments.

The carbon nanotube production process is preferably carried out in an agitated bed of a reactor. A reactor having an agitated bed is in process engineering terms different from, in particular, a fixed-bed reactor or a reactor without a bed, for example an entrained-flow reactor. In the case of a reactor having a bed, the substrate is physically located above a support. In the case of a fixed-bed reactor, the substrate can, for example, be present in a boat open at the top, with the boat in this case serving as support. The substrate is therefore essentially at rest during the process.

The carbon-containing precursor preferably contains or consists of an optionally substituted aliphatic, cyclic, heterocyclic, aromatic or heteroaromatic compound or a mixture thereof.

Here, aliphatic means an unbranched, branched and/or cyclic alkane, alkene or alkyne. The aliphatic molecules preferably have from about 1 to about 20, in particular from about 1 to about 12 and particularly preferably from about 2 to about 6, carbon atoms.

Practical experiments have shown that particularly good results are obtained when the carbon-containing precursor is an at least partially unsaturated or aromatic compound or the precursor contains such a compound or a mixture thereof.

Examples of partially unsaturated compounds are unbranched, branched and/or cyclic alkenes or alkynes, which can optionally be substituted.

The term “alkene” as used here refers to a hydrocarbon skeleton containing at least one carbon-carbon double bond. Carbon-containing precursors which can be used according to the invention are, for example, ethylene, propene, butene, butadiene, pentene, isoprene, hexene, 1-, 2- or 3-heptene, 1-, 2-, 3- or 4-octene, 1-nonene or 1-decene, with these optionally being able to be substituted, e.g. acrylonitrile.

The term “alkyne” as used here refers to a hydrocarbon skeleton containing at least one carbon-carbon triple bond. Preferred carbon-containing precursors which can be used are, for example, ethyne, propyne, butyne, pentyne, hexyne, 1-, 2- or 3-heptyne, 1-, 2-, 3- or 4-octyne, nonyne or decyne, with these optionally being able to be substituted.

Possible cyclic alkenes or alkynes are nonaromatic, monocyclic or polycyclic ring systems having, for example, from about 3 to about 10, preferably from about 5 to about 10, carbon atoms, which in the case of cycloalkenes contain at least one carbon-carbon double bond, in the case of cycloalkynes at least one carbon-carbon triple bond. Examples of monocyclic cycloalkenes are cyclopentene, cyclohexene, cycloheptene and the like. An example of a polycyclic alkene is norbornene.

The carbon-containing precursor can also contain an optionally substituted heterocyclic molecule or consist of the latter. Here, the term “heterocyclic” refers to a monocyclic or polycyclic ring system having from about 3 to about 10, preferably from about 5 to about 10, in particular from about 5 to about 6, carbon atoms, with one or more carbon atoms in the ring system being replaced by heteroatoms.

The term “heteroatom” as used here refers to one or more atoms selected from among oxygen, nitrogen or boron, with the oxidized forms in each case being encompassed.

In a particularly preferred embodiment of the invention, the heterocyclic compound used as carbon-containing precursors contain at least one carbon-carbon or carbon-heteroatom double bond.

The term “aromatic molecule” or “aromatic compound” as used here encompasses optionally substituted carbocyclic and heterocyclic compounds which contain a conjugated double bond system. Heterocyclic aromatics are also referred to as “heteroaromatics”. Examples of aromatic molecules according to the invention are optionally substituted monocyclic aromatic rings having from 0 to 3 heteroatoms selected independently from among O, N and B, or 8- to 12-membered aromatic bicyclic ring systems having from 0 to 5 heteroatoms, selected independently from among O, N and B. Carbon-containing precursors which can be used according to the invention are, for example, optionally substituted benzene, naphthalene, anthracene, pyridine, quinoline, isoquinoline, pyrazine, quinoxaline, acridine, pyrimidine, quinazoline, pyridazine, cinnoline, furan, benzofuran, isobenzofuran, pyrrole, indole, isoindole, imidazole, benzimidazole, purine, pyrazole, indazole, oxazole, benzoxazole, isoxazole, benzisoxazole.

When the expression “optionally substituted” is employed here, this means that the molecule or the compound can either be unsubstituted or bear a plurality of, preferably from 1 to 3, substituents. The substituents can be purely aliphatic or contain one or more heteroatoms. In a preferred embodiment, the substituents are selected from the group consisting of C₁-C₁₀-aliphatic, C₃-C₁₀-cycloaliphatic, C₆-C₁₀-aryl, 5- to 10-membered heteroaryl and 3- to 10-membered heterocyclyl, C₁-C₆-haloalkyl, C₁-C₁₀-alkoxy, halogen, NO₂, —OH, —CN.

Particularly preferred examples of carbon-containing precursors which have in practice achieved good to very good results are unsaturated hydrocarbons such as ethylene or acrylonitrile and aromatic molecules such as benzene or pyridine.

Catalysts which bring about a growth in length of carbon nanotubes are used, in particular, in the production of carbon nanotubes by known processes. Examples of catalysts which are frequently used are iron-, cobalt-, or nickel-containing catalysts.

In the catalytic production of carbon nanotubes, residues of the catalyst employed usually remain in the carbon nanotube powder produced. These carbon residues can be largely removed from the carbon nanotube powder by means of an acid wash, in particular by means of hydrochloric acid, so that acid-clean carbon nanotubes have only very low catalyst residue contents.

In a further embodiment of the novel CNT production process, a fluidized bed of a fluidized-bed reactor is used as agitated bed. A gas stream is fed into the CNT catalyst (and optionally into an auxiliary bed) through nozzle openings provided in the support, so that the CNT catalyst (and optionally the auxiliary bed) and the gas stream form a fluidized bed. The fluidized bed has liquid-like behavior in which the individual particles of the CNT catalyst are mixed in the gas stream. Apart from the good mixing of the CNT catalyst, good heat transfer and mass transfer are also achieved in the fluidized bed, so that essentially homogeneous process conditions are present in the fluidized bed. This results in a product having very homogeneous physical and chemical properties being obtained. In experiments, correspondingly high yields were also obtained by means of the fluidized-bed reactor.

As fluidized-bed reactor, it is possible to use, for example, a fused silica fluidized-bed reactor in which the reactor is formed essentially by a fused silica housing, for example a fused silica tube.

In an alternative embodiment of the process, the agitated bed can also be provided by means of a rotary tube reactor. A rotary tube reactor has a reactor tube whose longitudinal axis is aligned at a small angle of, for example, 1-5° to the horizontal. The rotary tube is mounted so as to be rotatable about its longitudinal axis and is able to be driven so as to rotate about this axis. To carry out the process, the CNT catalyst is firstly applied to the interior surface of the reactor tube. The reactor tube is subsequently rotated about its longitudinal axis while a carbon-containing precursor is introduced into the reactor tube. The process can be operated in cocurrent, i.e. reaction gas and catalyst or CNT move in the same direction, or in countercurrent. Preference is given to countercurrent operation.

In a further embodiment of the process in which the fluidized bed of a fluidized-bed reactor is used as agitated bed, gas flow through the fluidized bed is set in such a way that stable fluidization is ensured. Good yields have been found experimentally when using this gas flow range. To control the yield and the process itself, it is also possible to use gas mixtures, e.g. a mixture of inert carrier gas with the carbon-containing precursor.

Stable fluidization means that the gas flow has a velocity which is greater than or equal to the minimum fluidization velocity. As regards the determination of the minimum fluidization velocity, reference may be made to WO 2007/118668A2 whose contents are incorporated by reference into the present description. In particular, reference is made to the formula (1) on page 7 of WO 2007/118668A2 for determining the minimum fluidization velocity.

The carbon nanotube production process can be carried out continuously, pseudocontinuously or batchwise. In a preferred continuous process, CNT catalyst is fed continuously into the fluidized-bed reactor and/or carbon nanotubes produced are continuously taken off. In a batch process, the process is carried out using successive batches. For a batch, a CNT catalyst is initially placed in the reactor and the product obtained is essentially entirely taken out from the fluidized-bed reactor at the end of the process. In a pseudocontinuous process, only a certain part of the product is taken from the fluidized-bed reactor at the end of a process operation and a corresponding amount of the CNT catalyst is refilled.

In a further embodiment of the process, in particular in a pseudocontinuous or batch process, a process time in the range from 10 to 600 minutes, preferably from 10 to 120 minutes and in particular from 20 to 50 minutes, is set.

The process time is preferably set so that the bulk density of the carbon nanotubes or agglomerates produced after the end of the process is in the range from 10 to 500 g/l, preferably from 40 to 250 g/l and in particular from 60 to 150 g/1.

The production of carbon nanotubes having doped graphene-like layers can, in a further preferred embodiment of the process, be achieved by the carbon-containing precursor containing or consisting of a compound comprising carbon and at least one heteroatom from the group consisting of nitrogen and boron. As an alternative, the carbon-containing precursor can also contain at least two compounds, with at least one of these comprising carbon and at least another one of these comprising an element from the group consisting of nitrogen and boron.

Doping means that the otherwise graphene-like structure of a layer has foreign atoms in addition to the carbon atoms, preferably at least 1.5 at. %, more preferably at least 2 at. %, even more preferably at least 5 at. %, in particular at least 10 at. %, of foreign atoms. These can, for example, be arranged in place of carbon atoms in lattice sites or defects in the graphene lattice. An undoped layer is a graphene-like layer which has not been deliberately doped with foreign atoms, so that the defects within this layer are in the natural defect range, i.e. in particular in the range of ≦1 at. %, in particular ≦0.5 at. %.

The object of the invention is also achieved by a carbon nanotube powder which contains the above-described carbon nanotubes.

The carbon nanotubes of the carbon nanotube powder preferably have an average diameter of from 1 to 100 nm, more preferably from 3 to 50 nm, in particular from 5 to 25 nm. This diameter range corresponds to frequent industrial requirements and can readily be achieved by means of the invention.

The carbon nanotube powder preferably has a purity of at least 90%, preferably at least 95%, in particular at least 97%, particularly preferably at least 98%. For the present purposes, the purity is the proportion in % by weight of carbon nanotubes in the powder alongside other constituents such as, in particular, amorphous carbon and inorganic metal oxides. It has been found that carbon nanotube powders having a high purity can be produced by means of the present invention.

Carbon nanotubes having a ratio of length to external diameter of greater than 5, preferably greater than 100, are particularly preferably obtained.

The carbon nanotubes are particularly preferably obtained in the form of agglomerates, where the agglomerates have, in particular, an average diameter in the range from 0.05 to 5 mm, preferably from 0.1 to 2 mm, particularly preferably 0.2-1 mm.

The present invention therefore also provides for the use of fibrous carbon produced according to a novel method for producing fibrous carbon as described above in electrode materials, lithium ion batteries, polymeric, ceramic or metallic composites, in membranes, as catalyst support and for improving mechanical or electrically conductive properties of composites.

### EXAMPLES

### Experimental Part

### General Method for Experiments 1-9.

### a) Production of the Solutions:

Four solutions containing 19.4 g of Co(NO₃)₂*6H₂O in 50 ml of deionized water, 17.0 g of Mn(NO₃)₂.4H₂O in 50 ml of deionized water, Al(NO₃)₃.9H₂O (for amount, see Table 1) in 35 ml of deionized water and 30.6 g of Mg(NO₃)₂.6H₂O in 35 ml of deionized water were produced. The manganese nitrate hydrate solution and the cobalt nitrate hydrate solution were subsequently combined (solution A), and the aluminum nitrate hydrate solution and the magnesium nitrate hydrate solution were likewise combined (solution B). The two solutions (A and B) obtained were subsequently likewise combined and stirred for 5 minutes (solution C). A solution hereinafter referred to as solution D was produced by stirring 60 g of solid sodium hydroxide (NaOH) into 211 ml of deionized water so as to form a 22.1% strength by weight NaOH solution.

### b) Precipitation:

At room temperature (about 23° C.), the two solutions (C and D) were metered with intensive stirring into a multineck round-bottom flask containing an initial charge of 200 ml of deionized water and aluminum hydroxide (Reflamal® S20 from Dadco; for amount, see Table 1), with the pH being maintained at about pH=10 by addition of NaOH solution. The precipitation took about 30-40 minutes. After the metered addition was complete, the mixture was stirred for another 10 minutes.

### c) Filtration/Washing:

The solid obtained was filtered after the precipitation. The solid was subsequently washed by slurrying three times. The amount of washing water was about 11.

### d) Drying:

The catalyst was dried overnight at 120° C. in air.

### e) Milling/Sieving:

Before use in the CNT synthesis, which was carried out in a fluidized bed, the dried particles were milled by means of an IKA mill (M 20) and subsequently sieved by means of an AS 20 sieving machine from Retsch using an associated air jet sieve. The 0.03-0.1 mm fraction was used for the CNT synthesis. As a measure of the quality of millability, the percentage of the wanted particle size fraction based on material to be milled used was taken, with proportion of wanted particles >60%=good, 60-40%=moderate and <40%=poor.

### f) Calcination (Optional):

In some cases (see Table 1), the catalyst was heated at 400° C. in air for a period of 6 hours after milling/sieving and before testing in the CNT synthesis.

### g) CNT Synthesis:

The catalysts produced as described above were tested in a fluidized-bed apparatus on the laboratory scale. For this purpose, a defined amount of catalyst (0.5 g) was initially placed in a fused silica reactor which had an internal diameter of 5 cm and was heated from the outside by means of a cube furnace. The temperature of the fluidized bed was regulated by means of PID regulation. The temperature of the fluidized bed was determined by means of a thermocouple. Feed gases and inert diluent gases were fed into the reactor via electronically controlled mass flow regulators.

The reactor was then made inert by means of nitrogen and heated to a predetermined temperature (Table 1). The feed gas as a mixture of ethene, hydrogen and also the inert nitrogen were then immediately fed in. The volume flows (based on standard liters sl) were as follows: ethene 6 sl·min⁻¹, hydrogen 3 sl·min⁻¹ and nitrogen 1 sl·min⁻¹. The catalyst was supplied with the feed gases for a period of 33 minutes. The ongoing reaction was then stopped by interrupting the introduction of feed, the reactor was flushed with nitrogen, cooled and the contents of the reactor were taken out. The results are summarized in Table 1.

### Catalyst Activity Based on Mass of the “Incombustible/Undecomposable” Components of the Catalysts (“Loss-on-Ignition Yield”).

The oxidic catalyst for the CNT synthesis always contains a certain amount of water which depends on the history of the catalyst, in particular drying and calcination. To be able to make a better comparison of the actual yield of the experiments, the determination via the loss on ignition is therefore most suitable.

The amount of carbon deposited was determined by weighing. The “incombustible/undecomposable” proportion of the CNTs was determined by heating at 650° C. for 6 hours in air in a muffle furnace. The amount of carbon deposited based on the incombustible material (catalyst residue), hereinafter referred to as productivity, was defined on the basis of the mass of catalyst residue (mcat) and the weight gain after the reaction (mtotal−mcat): productivity=(mtotal−mcat)/mcat.

### Determination of the Specific Surface Area of the CNTs by the BET Method

The CNTs were pretreated as follows: 150° C./0.1 mbar/16 h;

N₂ adsorption by the multipoint BET method at −196° C. (method analogous to DIN ISO 9277)

### Determination of the Bulk Density of the CNTs

The determination was carried out in accordance with EN ISO 60.

TABLE 1

| | | | | | Temperature | | | Bulk |
|---|---|---|---|---|---|---|---|---|
| | Amount | Amount | | | of CNT | Productivity | BET of | density |
| Experiment | in [g] of | in [g] of | Catalyst | | synthesis | in g of | the CNT | of CNT |
| number | Al(OH)₃ | Al(NO₃)3*9H₂O | calcined | Millability | [° C.] | CNT/g cat | in [m²/g] | in g/l |
| 1 | 0 | 36 | no | good | 700 | 63.1 | 235 | 110 |
| 2 | 0.375 | 34.2 | no | good | 700 | 69.1 | 226 | 113 |
| 3 | 0.375 | 34.2 | yes | good | 700 | 81.3 | 229 | 128 |
| 4 | 1.87 | 27 | no | good | 700 | 92.3 | 237 | 134 |
| 5 | 3.75 | 18 | no | good | 600 | 42.5 | 333 | 126 |
| 6 | 3.75 | 18 | no | good | 650 | 73.6 | 290 | 159 |
| 7 | 3.75 | 18 | no | good | 700 | 106.5 | 258 | 171 |
| 8 | 5.62 | 9 | no | moderate | 700 | 100 | 274 | 193 |
| 9 | 7.49 | 0 | no | poor | 700 | 124.6 | 260 | 163 |

1.-19. (canceled)

20. A process for producing a catalyst consisting of at least one or more active metals and one or more support materials, which comprises the steps:
a) initial charging of a substrate in powder form which serves as support material for the catalyst and dispersion of the substrate powder in a solvent by mechanical action and setting of the dispersion to a pH of at least 8,
b) addition of one or more metal salt solutions containing precursor compounds of catalytically active metals and support metals, optionally after resetting of the selected pH so that these are coprecipitated and at the same time deposited on the previously dispersed substrate powder,
c) removal and isolation of the precipitated solid,
d) optionally washing of the solid with solvent,
e) spray-drying or drying and optionally milling and/or sieving (classification),
f) optionally calcining at 200° C.-950° C., with reduction or oxidation with subsequent reduction, and
g) reduction of the catalyst material formed.

21. The process as claimed in claim 20, wherein the compounds of one or more metals selected from the group consisting of: iron, cobalt, nickel, manganese and molybdenum are used as precursor compounds of the catalytically active metals.

22. The process as claimed in claim 20, wherein the compounds of cobalt and manganese are used as precursor compounds.

23. The process as claimed in claim 20, wherein the precursor compounds for support materials are selected from among one or more compounds of the group of compounds of magnesium, aluminum, silicon, titanium, barium and calcium.

24. The process as claimed in claim 20, wherein the precursor compounds for support materials are compounds of magnesium and/or aluminum.

25. The process as claimed in claim 20, wherein the metals are present in the form of their oxides or hydroxides, mixed oxides/hydroxides or mixed oxides or mixed hydroxides in the isolated solid from step c).

26. The process as claimed in claim 20, wherein the particle diameter of the main fraction of the catalyst after spray drying and/or milling and sieving as per step e) is in the range from 0.01 to 1 mm.

27. The process as claimed in claim 20, wherein the solvent for steps a), b) and optionally d) is one or more solvents selected from the group consisting of: water, alcohols, ethers, ketones.

28. The process as claimed in claim 20, wherein the dispersion is intensively homogenized, in particular by stirring or by means of high-pressure dispersion, during the addition of the metal salt solution in step b).

29. The process as claimed in claim 20, wherein the setting and resetting of the pH in the dispersion is effected by means of alkali metal hydroxide or ammonium hydroxide or alkali metal carbonate or ammonium carbonate or alkali metal hydrogencarbonate or ammonium hydrogencarbonate.

30. The process as claimed in claim 29, wherein the alkali metal compounds are compounds of lithium, sodium or potassium.

31. The process as claimed in claim 20, wherein the precipitation b) is carried out at a temperature of the dispersion of up to 100° C.

32. The process as claimed in claim 20, wherein the ratio of metal content in mol % of the catalytically active metal in the catalyst to metal of the support is from 90/10 to 5/95.

33. The process as claimed in claim 20, wherein the ratio of the content of initially charged substrate metal for the catalyst support to precipitated substrate metal for the catalyst support in mol % is from 1/99 to 95/5.

34. The process as claimed in claim 20, wherein the average particle diameter of the initially charged substrate powder in step a) is less than 1 mm.

35. A catalyst obtained from the process as claimed in claim 20.

36. A method producing fibrous carbon materials comprising utilizing the catalyst produced as claimed in claim 20.

37. A fibrous carbon material obtained by a process comprising
introducing a catalyst from the catalyst production process as claimed in claim 20 into a reactor,
producing a carbon nanotube by reaction of carbon-containing gases in the presence of the catalyst a temperature of from at least 500° C. to 1000° C., optionally in the presence of hydrogen and/or inert gas, and
discharging the carbon nanotubes and other reaction products from the reactor.

38. A article comprising the fibrous carbon materials as claimed in claim 37, wherein in the article is an electrode material, a lithium ion battery, a polymeric, a ceramic or metallic composite, a membrane, or a catalyst support.
